(19) United States
(12) Patent Application Publication
(10) Pub. No.: US 2017/0180593 A1
(43) Pub. Date: Jun. 22, 2017

(54) INFORMATION PROCESSING DEVICE, IMAGE PROCESSING DEVICE, INFORMATION PROCESSING METHOD, AND NON-TRANSITORY COMPUTER READABLE MEDIUM

(71) Applicant: FUJI XEROX CO., LTD., Tokyo (JP)

(72) Inventor: Yoshihiko NEMOTO, Kanagawa (JP)

(73) Assignee: FUJI XEROX CO., LTD., Tokyo (JP)

(21) Appl. No.: 15/148,030

(22) Filed: May 6, 2016

(30) Foreign Application Priority Data
Dec. 16, 2015 (JP) 2015-244864

(51) Int. Cl. H04N 1/32; G06K 7/10

(52) U.S. Cl. CPC H04N 1/32138; G06K 7/10366; H04N 2201/0094

(57) ABSTRACT

An information processing device includes a detection unit and a transmission unit. The detection unit detects whether or not the information processing device is attached to an object. If the information processing device is not attached, the transmission unit transmits an identifier of the information processing device and information indicating that the information processing device is not attached.

### CROSS-REFERENCE TO RELATED APPLICATIONS

This application is based on and claims priority under 35 USC 119 from Japanese Patent Application No. 2015-244864 filed Dec. 16, 2015.

### BACKGROUND

### Technical Field

The present invention relates to an information processing device, an image processing device, an information processing method, and a non-transitory computer readable medium.

### SUMMARY

According to an aspect of the invention, there is provided an information processing device including a detection unit and a transmission unit. The detection unit detects whether or not the information processing device is attached to an object. If the information processing device is not attached, the transmission unit transmits an identifier of the information processing device and information indicating that the information processing device is not attached.

### BRIEF DESCRIPTION OF THE DRAWINGS

An exemplary embodiment of the present invention will be described in detail based on the following figures, wherein:

FIG. 1 is a conceptual diagram illustrating an exemplary module configuration according to the exemplary embodiment;

FIG. 2 is a conceptual diagram illustrating an exemplary module configuration according to the exemplary embodiment;

FIGS. 3A to 3E each illustrate an exemplary system configuration in the case of implementing the exemplary embodiment;

FIG. 4 is a flowchart illustrating an exemplary process according to the exemplary embodiment;

FIG. 5 is a flowchart illustrating an exemplary process according to the exemplary embodiment;

FIGS. 6A and 6B respectively illustrate exemplary data structures of a management ID table and notification information;

FIG. 7 illustrates an exemplary data structure of a tag management table;

FIG. 8 illustrates an exemplary process according to the exemplary embodiment;

FIG. 9 is a flowchart illustrating an exemplary process according to the exemplary embodiment;

FIG. 10 is a flowchart illustrating an exemplary process according to the exemplary embodiment;

FIG. 11 illustrates an exemplary process according to the exemplary embodiment;

FIG. 12 is a flowchart illustrating an exemplary process according to the exemplary embodiment;

FIG. 13 illustrates an exemplary process according to the exemplary embodiment;

FIG. 14 illustrates an exemplary print on a tag information processing device; and

FIG. 15 is a block diagram illustrating an exemplary hardware configuration of a computer realizing the exemplary embodiment.

### DETAILED DESCRIPTION

An exemplary embodiment to implement the present invention is now described below with reference to the drawings.

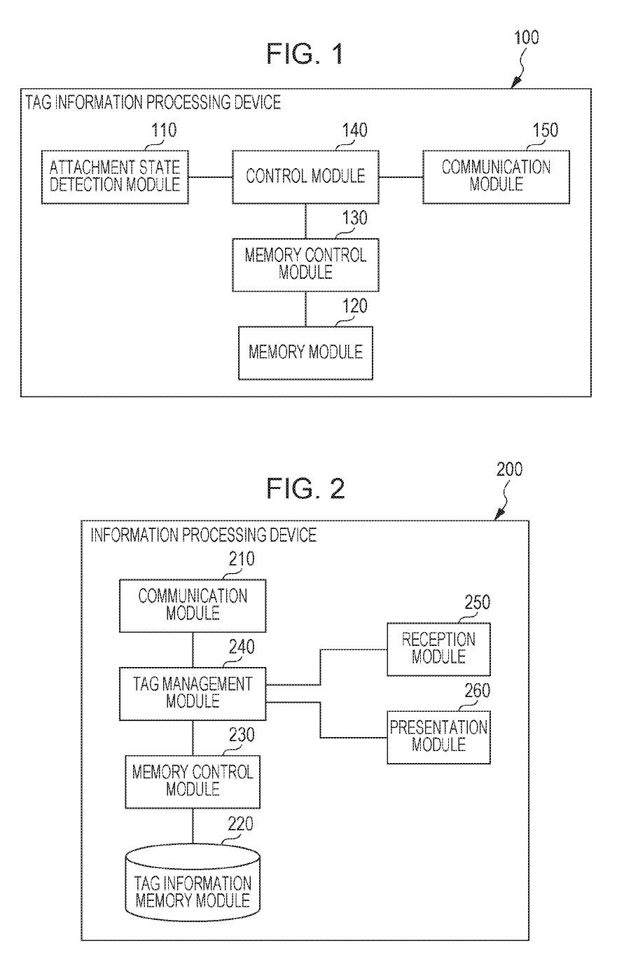

FIG. 1 is a conceptual diagram illustrating an exemplary module configuration according to the exemplary embodiment.

Note that the term “module” generally means a logically separable component of software (computer program), hardware, or the like. Accordingly, a module in the exemplary embodiment refers to not only a module in a computer program but also a module in a hardware configuration. Therefore, the exemplary embodiment will also illustrate a computer program for realizing the function of such a module (a program for causing a computer to execute each step, a program for causing a computer to function as each unit, or a program for causing a computer to realize each function), a system therefor, and a method therefor. For the convenience of description, “store Y”, “cause X to store Y”, or a similar expression will be used. In an exemplary embodiment illustrating a computer program, such an expression means to cause a memory device (X) to store Y or to perform control in such a manner as to cause a memory device (X) to store Y. Modules and functions may correspond to each other in a one-to-one relationship. Alternatively, in implementation, a single program may realize a single module or plural modules. Conversely, plural programs may realize a single module. Plural modules may be executed by a single computer, or a single module may be executed by plural computers in a distributed or parallel environment. In addition, a single module may include another module. The term “connect” is herein used to describe a physical connection or a logical connection (e.g., data transfer, instruction transmission, or data cross-reference). The term “predetermined” means a state where something is determined prior to a target process and includes the meaning of not only being determined before the start of a process according to the exemplary embodiment but also being determined before the target process even after the start of a process according to the exemplary embodiment, in accordance with the current or previous status and conditions. If there are plural “predetermined values”, these values may be mutually different values, or two or more values may be the same (it is needless to say that all the values may be the same). In addition, an expression such as “if A, B” is used to indicate that whether or not A is determined, and if it is determined that A, then B. However, this does not apply to the case where the determination as to whether or not A is unnecessary.

Furthermore, a system or a device may be configured by connecting plural computers, hardware components, devices, and the like to one another by using a communication unit, such as a network (including one-to-one-correspondence communication connection), or may be configured by a single computer, hardware component, device, and the like. Note that the terms “system” and “device” are used as synonyms. It may be needless to say that the term “system” does not mean a social mechanism (social system), which is settled by humans.

Furthermore, in the case where plural processes are performed by the respective modules or within a module, target information is read from a memory device in each process, and after the process has been performed, the process result is written to the memory device. Accordingly, description of the reading of information from the memory device before a process and the writing of information to the memory device after the process will be omitted in some cases. Note that examples of the memory device herein may include a hard disk, a random access memory (RAM), an external memory medium, a memory device connected via a communication line, and a register in a central processing unit (CPU).

A tag information processing device 100 according to the exemplary embodiment is a tag information processing device attachable to an object. As illustrated in the example in FIG. 1, the tag information processing device 100 includes an attachment state detection module 110, a memory module 120, a memory control module 130, a control module 140, and a communication module 150.

To manage an object, such as a fixed asset, equipment, fitment, or product, a tag (also referred to as a label, for example) is attached to the object. The tag is typically a sheet of paper or metal (e.g., plate for product management) having an adhesive surface (sticky surface). In addition, typically, the name of the object (e.g., product name), the management number, the date of purchase, expiry date, management department, and the like are printed on the tag.

As a technique disclosed in Japanese Patent No. 5569347, there is a radio frequency identification (RFID) label (tag) for contactless transmission and reception of data to and from an external device. The RFID label (tag) includes, on a label substrate, at least an optically variable device (OVD) layer, an antenna, an integrated circuit (IC) chip electrically connected to the antenna, and a first bonding layer used to attach the RFID label to an adherend. In the RFID label, a detachment layer or a second bonding layer formed of a material that is easily detached from the label substrate and a solvent-reactive conductive layer are formed between the label substrate and the OVD layer, and the OVD layer does not exhibit conductivity but has a function of producing optical effects. When the RFID label attached through the first bonding layer is detached from the adherend, the detachment layer or the second bonding layer is detached from the label substrate, the OVD layer is damaged, and the antenna is broken. In addition, when the RFID label is detached, a solvent is caused to act. While the solvent is acting, the solvent-reactive conductive layer exhibits conductivity, thereby losing a communication function. When the RFID label is detached from the adherend, the detachment layer or the second bonding layer is detached from the label substrate to damage the OVD layer. As a result, the RFID label is broken and becomes unable to be reused, thereby preventing forgery. In addition, the damage of the detachment layer or the OVD layer causes the antenna to be broken, whereby it is no longer possible to extract information from the RFID label. Alternatively, the detachment layer may be printed in a pattern on a surface of the label substrate, and the solvent-reactive conductive layer and the detachment layer may be printed in the same pattern. The solvent-reactive conductive layer may be provided between the label substrate and the detachment layer. The solvent-reactive conductive layer may include nano-order metal nanoparticles or metal salt. The solvent-reactive conductive layer may be colored by the action of the solvent. The antenna may be formed by spraying conductive ink so as to form an antenna wiring pattern. The OVD layer may produce optical effects in the visible light region.

The IC chip is connected to a coil antenna. In the reading of ID information or reading/writing of information from/to a general memory region, near-field radio communication using an electromagnetic field, radio wave, or the like from a dedicated data reading/writing device (hereinafter referred to as a reader/writer (RW) device) generates an induced electromotive force in the antenna. Then, the IC chip is driven, so that data transmitted from the RW device is received, and information stored in a memory region of the IC chip is transmitted wirelessly. Therefore, if such RFID tags are attached to products and the ID information in the ID chips is read by the RW device and transmitted to a computer system, it is possible to manage the products when putting them into and out of storage, while in storage, and when lending them, for example.

It is sufficient to use such an RFID tag as the tag information processing device 100, for example.

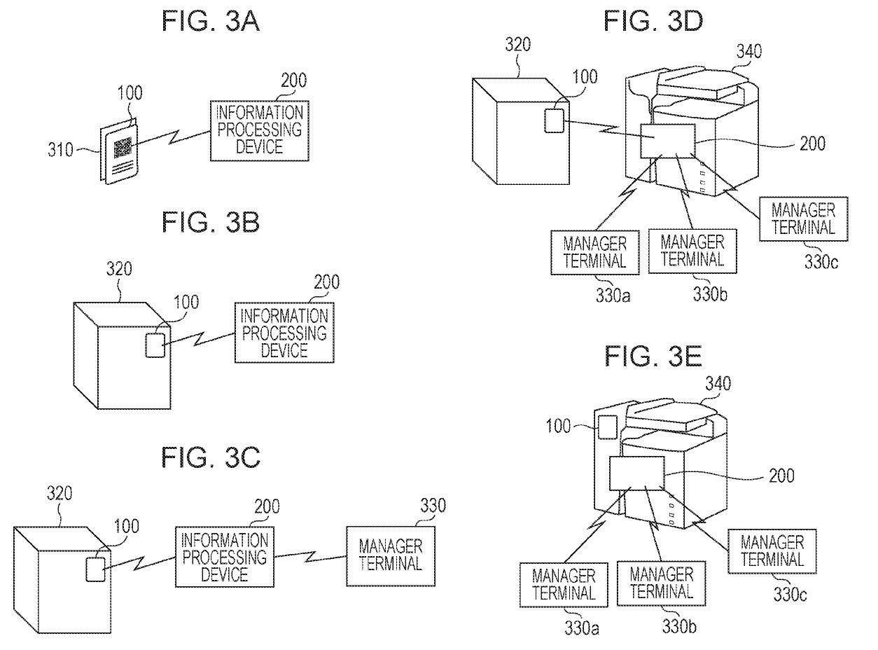

The attachment state detection module 110 is connected to the control module 140. The attachment state detection module 110 detects whether or not the tag information processing device 100 is attached to equipment 320 (see FIG. 3B, for example). For example, the above-described RFID tag may be used. Specifically, the solvent may act upon detachment of the RFID tag from the sheet. Alternatively, for example, it may be detected whether or not a sheet is detached from the adhesive surface (typically a rear surface) of the tag information processing device 100. For example, a part or all of the surface of the sheet may be conductive, and it may be detected that the detachment of the sheet causes the circuit of the main body of the tag information processing device 100 to be disconnected. Conversely, a part or all of the surface of the sheet may be non-conductive, and it may be detected that attachment of the tag information processing device 100, from which the sheet has been removed, to a conductive part of the object causes the circuit of the main body of the tag information processing device 100 to be electrically continuous.

In addition to whether or not the tag information processing device 100 is attached, any of the following three states may be separately detected: (1) state before attachment; (2) attached state; and (3) state of being detached after attached. The state (1) is the state where the tag information processing device 100 is yet to be used (the sticker has not been detached), the state (2) is the state where the tag information processing device 100 is attached to the object, and the state (3) is the state where, after the state (2), the tag information processing device 100 is detached from the object (including the state where the tag information processing device 100 is attached to the object again or another object, for example). For example, the following case may be determined to be the state (3): when the state (2) is set, information indicating this fact is stored, and while this information is stored, the state (1) or (2) is detected. In addition, for example, the above-described RFID tag may be used. Specifically, the solvent may act upon detachment of the RFID tag from the sheet.

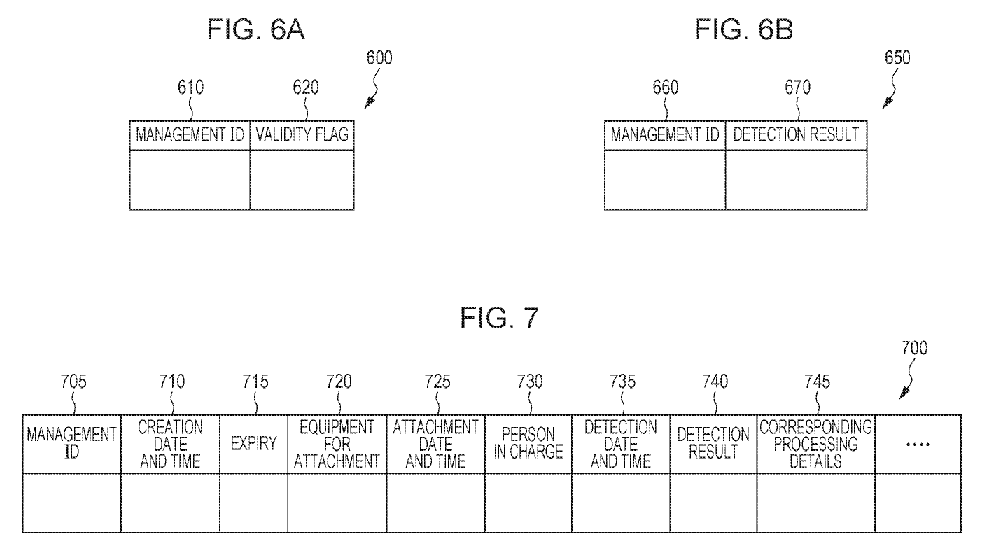

The memory module 120 is connected to the memory control module 130. The memory module 120 stores at least an identifier of the tag information processing device 100. For example, the memory module 120 stores a management ID table 600 or notification information 650. FIGS. 6A and 6B respectively illustrate exemplary data structures of the management ID table 600 and the notification information 650. In the exemplary data structure of the management ID table 600 illustrated in FIG. 6A, the management ID table 600 includes a management ID field 610 and a validity flag field 620. In the exemplary embodiment, the management ID field 610 stores information (management identification (ID)) for uniquely identifying the tag information processing device 100. Note that the management ID may be information for uniquely identifying an object to which the tag information processing device 100 is to be attached. The validity flag field 620 stores a validity flag indicating whether or not the management ID is valid (or whether or not the management ID is invalid).

FIG. 6B illustrates the exemplary data structure the notification information 650. The notification information 650 includes a management ID field 660 and a detection result field 670. The management ID field 660 stores the management ID. The detection result field 670 stores the result of detection by the attachment state detection module 110.

The memory control module 130 is connected to the memory module 120 and the control module 140. The memory control module 130 reads and writes information (including initialization) in the memory module 120 under the control of the control module 140.

The control module 140 is connected to the attachment state detection module 110, the memory control module 130, and the communication module 150. If the tag information processing device 100 is not attached to the object, the control module 140 controls the communication module 150 in such a manner that information indicating that the tag information processing device 100 is not attached is transmitted together with the identifier of the tag information processing device 100.

If the tag information processing device 100 is attached to the object, the control module 140 may cause information indicating that the tag information processing device 100 is attached to be transmitted together with the identifier of the tag information processing device 100.

If the communication module 150 receives an initialization instruction, the control module 140 may control the memory control module 130 in such a manner that information stored in the tag information processing device 100 (information stored in the memory module 120) is initialized. Any kind of initialization may be performed as long as the tag information processing device 100 is set to a state where the tag information processing device 100 has no function for managing an object. For example, the initialization may be storing information indicating that the tag information processing device 100 has no function for managing an object, deleting information in the memory module 120 (e.g., the identifier of the tag information processing device 100), and the like.

The communication module 150 is connected to the control module 140. The communication module 150 performs communication with an information processing device outside the tag information processing device 100 under the control of the control module 140. This communication is typically near-field radio communication. The communication module 150 may receive an initialization instruction from the information processing device outside the tag information processing device 100.

FIG. 2 is a conceptual diagram illustrating an exemplary module configuration according to the exemplary embodiment.

An information processing device 200 includes a communication module 210, a tag information memory module 220, a memory control module 230, a tag management module 240, a reception module 250, and a presentation module 260.

The communication module 210 is connected to the tag management module 240. The communication module 210 performs communication with the communication module 150 of the tag information processing device 100. This communication is typically near-field radio communication.

The tag information memory module 220 is connected to the memory control module 230. The tag information memory module 220 stores information for managing the tag information processing device 100. For example, the tag information memory module 220 stores a tag management table 700. FIG. 7 illustrates an exemplary data structure of the tag management table 700. The tag management table 700 includes a management ID field 705, a creation date and time field 710, an expiry field 715, an equipment-for-attachment field 720, an attachment date and time field 725, a person-in-charge field 730, a detection date and time field 735, a detection result field 740, a corresponding processing details field 745, and the like. The management ID field 705 stores the management ID of each tag information processing device 100. The creation date and time field 710 stores the date and time at which the tag information processing device 100 was created. The expiry field 715 stores the expiry date of the tag information processing device 100. The equipment-for-attachment field 720 stores equipment to which the tag information processing device 100 is to be attached (or is attached). The attachment date and time field 725 stores the date and time (year, month, day, hour, minute, second, a unit smaller than a second, or a combination thereof) at which the tag information processing device 100 was attached. The person-in-charge field 730 stores a person in charge of the tag information processing device 100 (or the equipment to which the tag information processing device 100 is attached). The detection date and time field 735 stores the date and time at which the tag information processing device 100 was detected. The detection result field 740 stores a result of the detection (e.g., whether or not the tag information processing device 100 is attached or whether or not initialization is performed). The corresponding processing details field 745 stores details of corresponding processing (e.g., attachment instruction, detachment instruction, or initialization instruction) performed on the tag information processing device 100. Note that the number of combinations of the detection date and time field 735, the detection result field 740, and the corresponding processing details field 745 is equal to the number of times the tag information processing device 100 is detected (or the number of communications with the tag information processing device 100).

The memory control module 230 is connected to the tag information memory module 220 and the tag management module 240. The memory control module 230 reads and writes information in the tag information memory module 220 under the control of the tag management module 240.

The tag management module 240 is connected to the communication module 210, the memory control module 230, the reception module 250, and the presentation module 260. If the communication module 210 receives information indicating that the tag information processing device 100 is attached to the object from the tag information processing device 100, the tag management module 240 extracts expiry information corresponding to the identifier of the tag information processing device 100. If the expiry date indicated by the expiry information has already passed, the presentation module 260 is controlled to output a warning. If the tag information processing device 100 is initialized, information indicating that the tag information processing device 100 is invalid may be presented. The information indicating that the tag information processing device 100 is invalid may include an action to be performed in the case where the tag information processing device 100 is invalid, such as an instruction to detach the tag information processing device 100 from the object.

If the communication module 210 receives, from plural tag information processing devices 100, information indicating that the tag information processing devices 100 are attached to a single object, the tag management module 240 may extract the creation date and time information corresponding to the identifier of each of the tag information processing devices 100 and may control the communication module 210 in such a manner that an initialization instruction is transmitted to a tag information processing device 100 among the tag information processing devices 100 having an older creation date and time than the other tag information processing devices 100. Accordingly, it is possible to initialize the tag information processing devices 100 other than the tag information processing device 100 having the latest creation date and time.

In addition, in the case where the communication module 210 receives, from a tag information processing device 100, information indicating that the tag information processing device 100 is attached to the object and where the tag information processing device 100 has been previously detached from the object, the tag management module 240 may control the communication module 210 in such a manner that an initialization instruction is transmitted to the tag information processing device 100. If the communication module 210 receives, from the tag information processing device 100, information indicating that the tag information processing device 100 has been attached to and then detached from the object, the tag management module 240 may control the communication module 210 in such a manner that an initialization instruction is transmitted to the tag information processing device 100.

The reception module 250 is connected to the tag management module 240. The reception module 250 receives user operation through a mouse, a keyboard, or a touch panel, user operation via a voice by using a microphone, or user operation via line of sight, gesture, or the like by using a camera, for example. The reception module 250 receives instructions to start communication with the tag information processing device 100, the management of the tag information processing device 100, and the like.

The presentation module 260 is connected to the tag management module 240. The presentation module 260 presents a warning, for example, under the control of the tag management module 240. Note that the presentation may be not only display on a display device, such as a display, but also print by using a printing device, such as a printer, voice output by using a voice outputting device, such as a speaker, vibration, or the like, or a combination thereof.

By using the tag information processing device 100 and the information processing device 200, it is possible to manage whether or not a label is attached in an appropriate manner, specifically, whether or not the tag information processing device 100 is actually attached to the object or whether or not an expired tag information processing device 100 is attached without updating. In addition, it is also possible to detect an inappropriate use of the tag information processing device 100, such as detachment of the tag information processing device 100 from the object and attachment thereof to another object.

FIGS. 3A to 3E each illustrate an exemplary system configuration in the case of implementing the exemplary embodiment.

FIG. 3A illustrates an exemplary configuration including the tag information processing device 100 and the information processing device 200 where the tag information processing device 100 is yet to be attached to the equipment 320. As an initial state, the tag information processing device 100 is attached to a sheet 310. The tag information processing device 100 and the information processing device 200 are connected to each other by wireless communication. For example, the information processing device 200 manages the number of tag information processing devices 100, management IDs thereof, and the like.

FIG. 3B illustrates an exemplary configuration including the tag information processing device 100 attached to the equipment 320 and the information processing device 200. The tag information processing device 100 is attached to the equipment 320. The tag information processing device 100 and the information processing device 200 are connected to each other by wireless communication. For example, the information processing device 200 may receive, from the tag information processing device 100, information indicating that the tag information processing device 100 is attached and may determine whether or not the expiry date has passed.

FIG. 3C illustrates an exemplary configuration including the tag information processing device 100, the information processing device 200, and a manager terminal 330 where the tag information processing device 100 is attached to the equipment 320. A person in charge, who attaches the tag information processing device 100 to the equipment 320, for example, uses the information processing device 200. The manager terminal 330 is used by a manager who manages equipment and the like, such as the equipment 320, and may be a mobile terminal, for example.

The tag information processing device 100 is attached to the equipment 320. The tag information processing device 100 and the information processing device 200 are connected to each other by wireless communication. The information processing device 200 and the manager terminal 330 are connected to each other via a communication line. The information processing device 200 and the manager terminal 330 may perform communication via any of a wireless line, a wired line, or a combination thereof, and a communication infrastructure, such as the Internet or an intranet, may be used, for example. In addition, the functions of the manager terminal 330 may be realized as a cloud service.

FIG. 3D illustrates an exemplary configuration where an image processing device 340 includes the information processing device 200 and functions as a relay device between the tag information processing device 100 and the manager terminal 330.

The tag information processing device 100 is attached to the equipment 320. The image processing device 340 includes the information processing device 200. The tag information processing device 100 and the information processing device 200 are connected to each other by wireless communication. The information processing device 200 is connected to a manager terminal 330a, a manager terminal 330b, and a manager terminal 330c via communication lines.

In addition, the image processing device 340 may obtain, from the tag information processing device 100, information for uniquely identifying the tag information processing device 100 and may print details of the obtained information on the surface of the tag information processing device 100. For example, plural tag information processing devices 100 may be formed in a sheet roll or on a hard plate, and for each tag information processing device 100, the management ID, the name of the object (e.g., product name), the date of purchase, the expiry date, the management department, and the like may be extracted from the information processing device 200 or the manager terminal 330 in order to print such information.

FIG. 3E illustrates an exemplary configuration where the image processing device 340 includes the information processing device 200 and where the tag information processing device 100 is attached to the image processing device 340. In this case, the object is the image processing device 340. The information processing device 200 is connected to the manager terminal 330a, the manager terminal 330b, and the manager terminal 330c via communication lines. In addition, the information processing device 200 may perform communication with a tag information processing device 100 attached to other equipment 320.

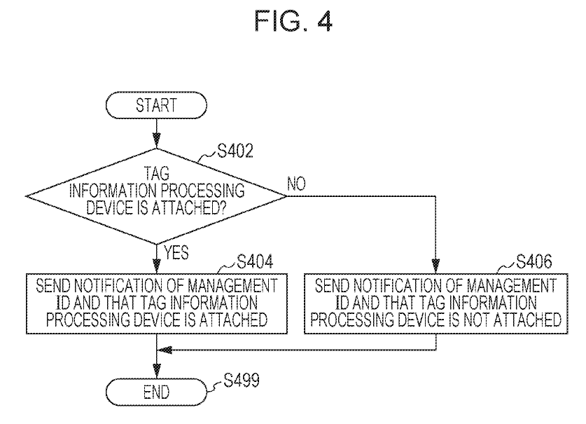

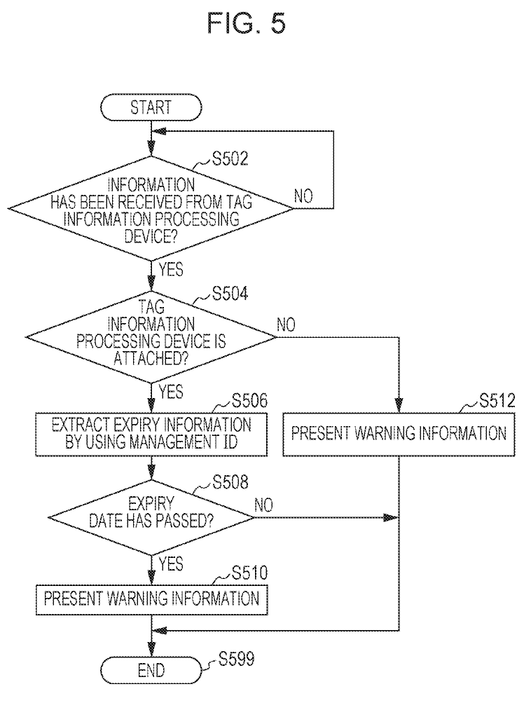

FIG. 4 is a flowchart illustrating an exemplary process according to the exemplary embodiment (the tag information processing device 100).

In step S402, the attachment state detection module 110 determines whether or not the tag information processing device 100 is attached to the equipment 320. If the tag information processing device 100 is attached, the process proceeds to step S404; if not, the process proceeds to step S406.

In step S404, the control module 140 notifies the information processing device 200 of the management ID and that the tag information processing device 100 is attached, and the process ends (step S499).

In step S406, the control module 140 notifies the information processing device 200 of the management ID and that the tag information processing device 100 is yet to be attached, and the process ends (step S499).

FIG. 5 is a flowchart illustrating an exemplary process according to the exemplary embodiment (the information processing device 200).

In step S502, the communication module 210 determines whether or not information has been received from the tag information processing device 100. If information has been received, the process proceeds to step S504; if not, the communication module 210 waits for the reception.

In step S504, from details of the received information, the tag management module 240 determines whether or not the tag information processing device 100 is attached. If the tag information processing device 100 is attached, the process proceeds to step S506; if not, the process proceeds to step S512.

In step S506, the tag management module 240 extracts expiry information by using the received management ID.

In step S508, the tag management module 240 determines whether or not the expiry date has passed. If the expiry date has passed, the process proceeds to step S510; if not, the process ends (step S599).

In step S510, the presentation module 260 presents warning information (indicating that the tag information processing device 100 has expired).

In step S512, the presentation module 260 presents warning information (for attaching the tag information processing device 100).

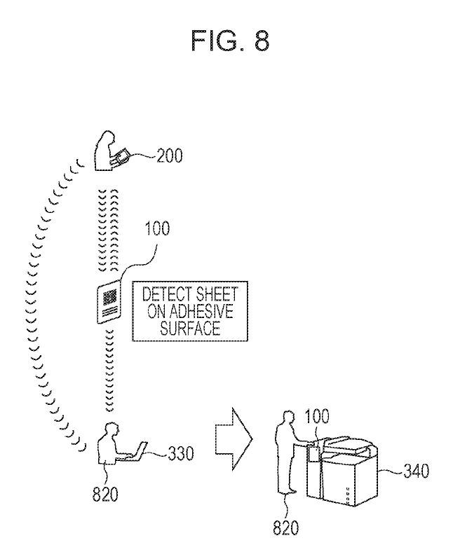

FIG. 8 illustrates an exemplary process according to the exemplary embodiment. The exemplary process in FIG. 8 is performed according to the flowcharts illustrated in FIGS. 4 and 5.

First, the tag information processing device 100 detects that a sheet is present on the adhesive surface of the tag information processing device 100 (that the tag information processing device 100 is not attached to the image processing device 340, which is the object), and transmits this information to the information processing device 200 together with the management ID of the tag information processing device 100.

Since the tag information processing device 100 is yet to be attached, the information processing device 200 notifies a person-in-charge 820 (specifically, the manager terminal 330 owned by the person-in-charge 820) of the instruction to attach the tag information processing device 100 to the image processing device 340.

In accordance with the instruction, the person-in-charge 820 attaches the tag information processing device 100 to the image processing device 340.

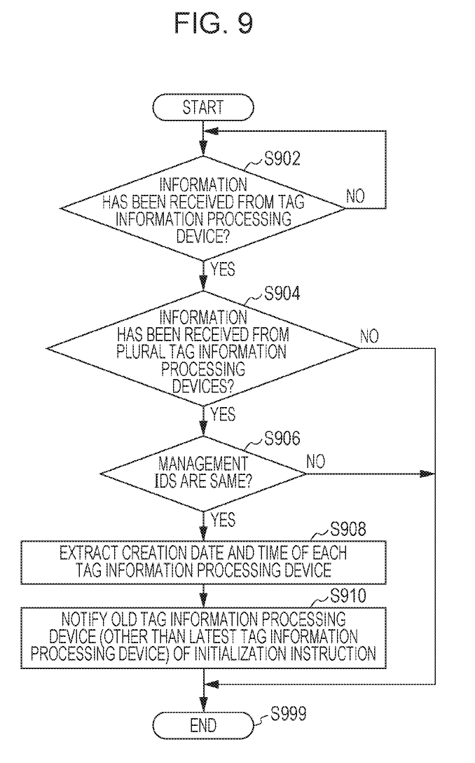

FIG. 9 is a flowchart illustrating an exemplary process according to the exemplary embodiment (the information processing device 200).

In step S902, the communication module 210 determines whether or not information has been received from the tag information processing device 100. If information has been received, the process proceeds to step S904; if not, the communication module 210 waits for the reception. In step S902, the tag information processing device 100 is either attached to or yet to be attached to the image processing device 340.

In step S904, the tag management module 240 determines whether or not information has been received from plural tag information processing devices 100. If information has been received from the plural tag information processing devices 100, the process proceeds to step S906; if not, the process ends (step S999).

In step S906, the tag management module 240 determines whether or not the management IDs of the plural tag information processing devices 100 are the same. If the management IDs are the same, the process proceeds to step S908; if not, the process ends (step S999).

In step S908, the tag management module 240 extracts the creation date and time of each of the tag information processing devices 100.

In step S910, the tag management module 240 notifies an old tag information processing device 100 (a tag information processing device 100 other than the latest tag information processing device 100) of an initialization instruction.

In the case where the management IDs of the tag information processing devices 100 are different (i.e., if the tag information processing devices 100 having the same management ID are not used for the same equipment), if the determination in step S904 is YES, step S908 may be performed, skipping the determination in step S906.

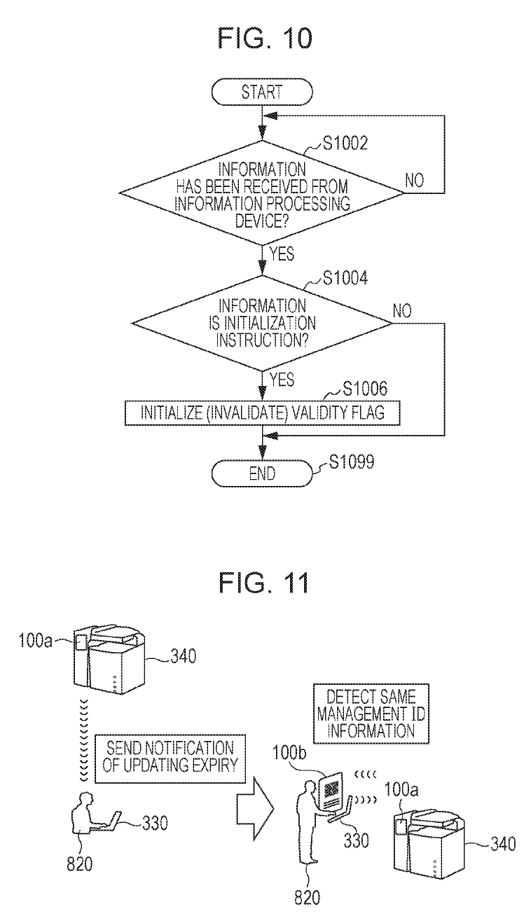

FIG. 10 is a flowchart illustrating an exemplary process according to the exemplary embodiment (the tag information processing device 100).

In step S1002, the communication module 150 determines whether or not information has been received from the information processing device 200. If information has been received, the process proceeds to step S1004; if not, the communication module 150 waits for the reception.

In step S1004, the control module 140 determines whether or not the details of the received information correspond to an initialization instruction. If the received information details correspond to an initialization instruction, the process proceeds to step S1006; if not, the process ends (step S1099).

In step S1006, the control module 140 initializes (invalidates) a validity flag in the memory module 120.

FIG. 11 illustrates an exemplary process according to the exemplary embodiment. The exemplary process in FIG. 11 is performed according to the flowcharts illustrated in FIGS. 9 and 10.

The manager terminal 330 detects a tag information processing device 100a attached to the image processing device 340 and detects that the expiry date of the tag information processing device 100a has passed.

The person-in-charge 820 prepares a new tag information processing device 100, i.e., a tag information processing device 100b, and attaches the tag information processing device 100b to the image processing device 340. In this case, the manager terminal 330 detects the tag information processing device 100a that has already been attached to the image processing device 340, and sends an initialization instruction to the old tag information processing device 100a. Note that the tag information processing device 100b may have been attached to the image processing device 340 or may not have been attached yet. It is sufficient that the manager terminal 330 is able to detect the tag information processing device 100a and the tag information processing device 100b by using near-field communication. A condition for sending an initialization instruction may be that the tag information processing devices 100, which are the tag information processing device 100a and the tag information processing device 100b, have the same management ID.

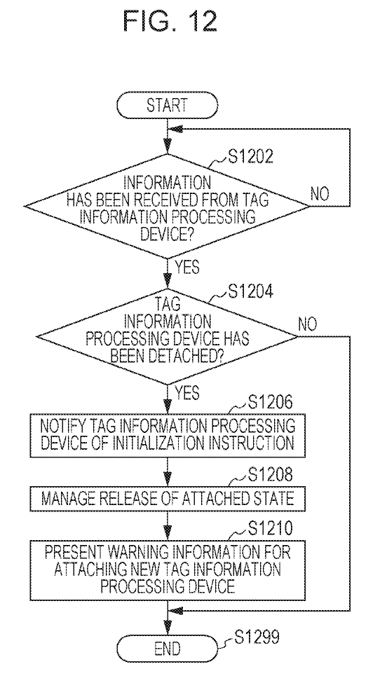

FIG. 12 is a flowchart illustrating an exemplary process according to the exemplary embodiment (the information processing device 200).

In step S1202, the communication module 210 determines whether or not information has been received from the tag information processing device 100. If the information has been received, the process proceeds to step S1204; if not, the communication module 210 waits for the reception.

In step S1204, the tag management module 240 determines whether or not the tag information processing device 100 has been detached from the equipment 320. If the tag information processing device 100 has been detached, the process proceeds to step S1206; if not, the process ends (step S1299).

In step S1206, the tag management module 240 notifies the tag information processing device 100 of an initialization instruction.

In step S1208, the tag management module 240 manages the release of the attached state.

In step S1210, the presentation module 260 presents warning information for attaching a new tag information processing device 100.

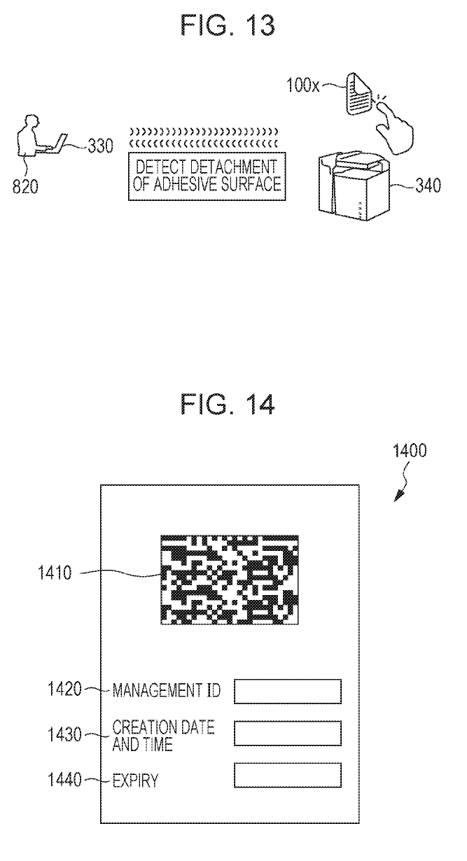

FIG. 13 illustrates an exemplary process according to the exemplary embodiment. The exemplary process in FIG. 13 is performed according to the flowcharts illustrated in FIGS. 12 and 10.

The manager terminal 330 detects a tag information processing device 100x that has been attached to the image processing device 340 and detects that the tag information processing device 100x has been detached from the image processing device 340. That is, the manager terminal 330 detects that a sticker on an adhesive surface of the tag information processing device 100x has been detached and that the tag information processing device 100x is not being attached to the image processing device 340. Then, the manager terminal 330 sends an initialization instruction to the tag information processing device 100x, and the tag information processing device 100x performs initialization according to the flowchart illustrated in FIG. 10.

FIG. 14 illustrates an exemplary print on a tag information processing device 1400.

An information image 1410, a management ID field 1420, a creation date and time field 1430, and an expiry field 1440 are printed on the surface of the tag information processing device 1400.

The information image 1410 indicates information of the management ID field 1420 and the like. Note that the information image refers to an image code that is systematically created to indicate electronic data in a machine readable manner and specifically is a one-dimensional barcode, a two-dimensional barcode, or the like. As the two-dimensional barcode, a Quick Response Code (QR Code, registered trademark) may be used.

A management ID received by the image processing device 340 as a result of communication with the tag information processing device 100 is printed in the management ID field 1420.

The date and time (for example, the printing date and time is also possible) at which the tag information processing device 100 was created is printed in the creation date and time field 1430 by the image processing device 340.

The expiry date obtained by the image processing device 340 from the information processing device 200 as a result of communication with the information processing device 200 by using the management ID obtained from the tag information processing device 100 as a search key is printed in the expiry field 1440.

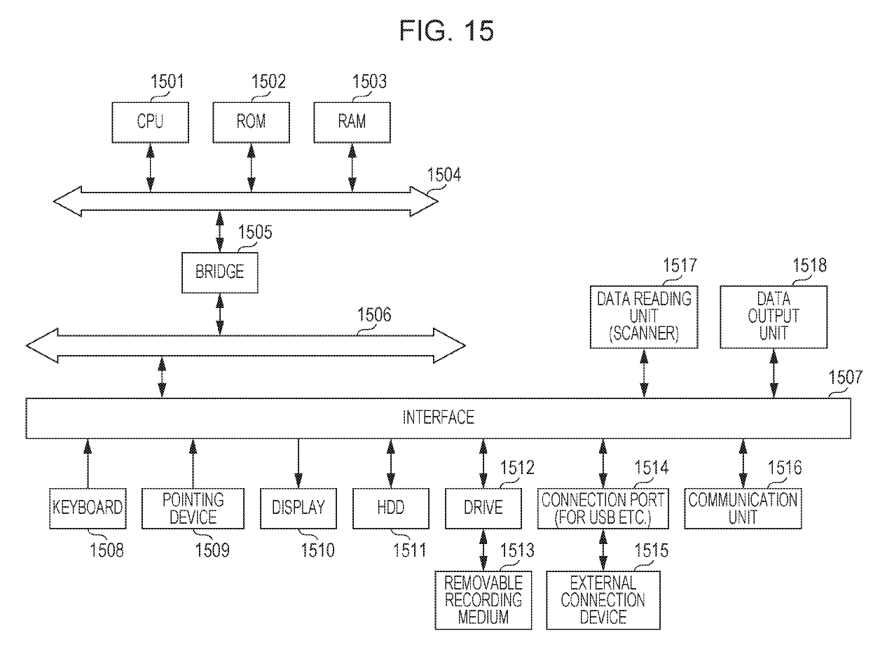

An exemplary hardware configuration of the information processing device (the information processing device 200, the manager terminal 330, and the image processing device 340) according to the exemplary embodiment will be described with reference to FIG. 15. Note that an exemplary hardware configuration of the tag information processing device 100 is disclosed in Japanese Patent No. 5569347, for example. The configuration illustrated in FIG. 15 is an exemplary hardware configuration that is realized by, for example, a personal computer (PC) and that includes a data reading unit 1517, such as a scanner, and a data output unit 1518, such as a printer.

A central processing unit (CPU) 1501 is a control unit that executes processes in accordance with computer programs that describe sequences of executing the modules described above in the exemplary embodiment, in other words, the following modules: the communication module 210, the memory control module 230, the tag management module 240, the reception module 250, the presentation module 260, and the like.

A read only memory (ROM) 1502 stores programs, operating parameters, and the like used by the CPU 1501. A random access memory (RAM) 1503 stores programs used in the execution of the CPU 1501, parameters that change appropriately in the execution, and the like. The CPU 1501, the ROM 1502, and the RAM 1503 are connected to one another via a host bus 1504, such as a CPU bus.

The host bus 1504 is connected to an external bus 1506, such as a peripheral component interconnect/interface (PCI) bus, via a bridge 1505.

A keyboard 1508 and a pointing device 1509, such as a mouse, are devices manipulated by an operator. A display 1510, such as a liquid crystal display device or a cathode ray tube (CRT), displays various kinds of information as text or image information. The display 1510 may be a touch screen, for example, having the functions of both the pointing device 1509 and the display 1510.

A hard disk drive (HDD) 1511 includes a built-in hard disk (a flash memory or the like is also possible) and drives and causes the hard disk to record or reproduce information and programs executed by the CPU 1501. The hard disk realizes the function of the tag information memory module 220, for example. Furthermore, the hard disk also stores other various kinds of data, various computer programs, and the like.

A drive 1512 reads data or programs recorded on a removable recording medium 1513, such as a loaded magnetic disk, optical disc, magneto-optical disk, or semiconductor memory, and supplies the data or programs to the RAM 1503 connected to the drive 1512 via an interface 1507, the external bus 1506, the bridge 1505, and the host bus 1504. Note that the removable recording medium 1513 is also usable as a data recording region.

A connection port 1514 is a port to be connected to an external connection device 1515 and includes a connection portion for a USB or IEEE 1394 connector, for example. The connection port 1514 is connected to, for example, the CPU 1501 via the interface 1507, the external bus 1506, the bridge 1505, the host bus 1504, and the like. A communication unit 1516 is connected to a communication line and executes data communication processes with external devices. The data reading unit 1517 is a scanner, for example, and executes a document reading process. The data output unit 1518 is a printer, for example, and performs a document data output process.

The hardware configuration of the information processing device illustrated in FIG. 15 is one of exemplary configurations. The exemplary embodiment is not limited to the configuration illustrated in FIG. 15 and may be any configuration as long as it is possible to execute the modules described in the exemplary embodiment. For example, some modules may be configured by dedicated hardware (e.g., application specific integrated circuit (ASIC)), some modules may be included in an external system and may be connected to the information processing device via a communication line, and plural systems illustrated in FIG. 15 may be connected to one another via a communication line and may operate in cooperation with one another. In particular, some modules may be incorporated in, not only a personal computer, but also a mobile information communication device (e.g., a cell phone, a smartphone, a mobile device, or a wearable computer), a home information appliance, a robot, a copying machine, a facsimile, a scanner, a printer, a multifunction peripheral (an image processing device having any two or more of a scanner function, a printer function, a copying machine function, a facsimile function, and the like), and the like.

The above-described program may be provided by being stored in a recording medium. Alternatively, the program may be provided by using a communication unit. In such a case, for example, the program may correspond to a computer readable recording medium storing a program.

The term “computer readable recording medium storing a program” refers to a computer readable recording medium that stores a program and that is used to, for example, install, execute, and distribute the program.

Examples of the recording medium include the following: a digital versatile disc (DVD), such as “DVD-R, DVD-RW, DVD-RAM, and the like” as standardized by the DVD Forum or “DVD+R, DVD+RW, and the like” as standardized by the DVD+RW Alliance; a compact disc (CD), such as a CD read only memory (CD-ROM), a CD recordable (CD-R), or a CD rewritable (CD-RW); a Blu-ray Disc (registered trademark); a magneto-optical disk (MO); a flexible disk (FD); a magnetic tape; a hard disk; a read only memory (ROM); an electrically erasable programmable read only memory (EEPROM) (registered trademark); a flash memory; a random access memory (RAM); and a secure digital (SD) memory card.

A part or all of the program may be, for example, recorded on the recording medium and stored or distributed. Alternatively, a part or all of the program may be transmitted by communication using a transmission medium, such as a wired network used for a local area network (LAN), a metropolitan area network (MAN), a wired area network (WAN), the Internet, an intranet, or an extranet; a wireless communication network; or a combination thereof. Further alternatively, a part or all of the program may be transmitted on a carrier wave.

The above-described program may be a part or all of another program, or may be recorded on a recording medium together with another program. The program may be divided into sub-parts and recorded on plural recording media. The program may be recorded in any form, such as by being compressed or encrypted, as long as it is possible to restore the program.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing device comprising:
at least one hardware processor configured to implement:
a detection unit that detects whether the information processing device is attached to an object by detecting whether a sheet is present on an adhesive surface of the information processing device; and
a transmission unit that transmits, if the information processing device is not attached, an identifier of the information processing device and information indicating that the information processing device is not attached.

2. The information processing device according to claim 1, wherein, if the information processing device is attached, the transmission unit transmits the identifier of the information processing device and information indicating that the information processing device is attached.

3. The information processing device according to claim 2, wherein the at least one hardware processor is further configured to implement:
a reception unit that receives an initialization instruction; and
an initialization unit that initializes, when the initialization instruction is received, information stored in the information processing device.

4. An information processing device comprising:
at least one first hardware processor configured to implement:
an extraction unit that extracts expiry information corresponding to an identifier of an attachable information processing device if information indicating that the attachable information processing device is attached is received from the attachable information processing device; and
an output unit that outputs a warning if an expiry date indicated by the expiry information has passed,
wherein the attachable information processing device includes at least one second hardware processor configured to implement:
a detection unit that detects whether the attachable information processing device is attached to an object by detecting whether a sheet is present on an adhesive surface of the attachable information processing device, and
a transmission unit that transmits, if the attachable information processing device is not attached, the identifier of the attachable information processing device and information indicating that the attachable information processing device is not attached, and if the attachable information processing device is attached, the identifier of the attachable information processing device and information indicating that the attachable information processing device is attached.

5. The information processing device according to claim 4, wherein the at least one first hardware processor is further configured to implement a transmission unit,
wherein, if information indicating that a plurality of attachable information processing devices are attached to a single object is received from the attachable information processing devices, the extraction unit extracts creation dates and times corresponding to identifiers of the attachable information processing devices, and the transmission unit sends an initialization instruction to an attachable information processing device having an older creation date and time than another of the attachable information processing devices, and
wherein each of the plurality of attachable information processing devices includes at least one respective hardware processor configured to implement respective ones of:
a respective detection unit that detects whether a respective one of the plurality of attachable information processing devices is attached to an object, and
a respective transmission unit that transmits, if the respective one of the plurality of attachable information processing devices is not attached, a respective identifier of the respective one of the plurality of attachable information processing devices and respective information indicating that the respective one of the plurality of attachable information processing devices is not attached, and if the respective one of the plurality of attachable information processing devices is attached, the respective identifier of the respective one of the plurality of attachable information processing devices and respective information indicating that the respective one of the plurality of attachable information processing devices is attached, wherein
the respective one of the plurality of attachable information processing devices comprises the respective detection unit and the respective transmission unit.

6. The information processing device according to claim 4, wherein the at least one first hardware processor is configured to implement a transmission unit that sends an initialization instruction to the attachable information processing device if information indicating that the attachable information processing device is attached is received from the attachable information processing device in a case where the attachable information processing device has been previously detached.

7. An image processing device comprising:
at least one first hardware processor configured to implement:
an obtaining unit that obtains, from an attachable information processing device, information for uniquely identifying the attachable information processing device; and
a printing unit that prints content of the information on a surface of the attachable information processing device,
wherein the attachable information processing device includes at least one second hardware processor configured to implement:
a detection unit that detects whether the attachable information processing device is attached to an object by detecting whether a sheet is present on an adhesive surface of the information processing device, and
a transmission unit that transmits, if the attachable information processing device is not attached, an identifier of the attachable information processing device and information indicating that the attachable information processing device is not attached.

8. An information processing method comprising:
detecting whether an information processing device is attached to an object by detecting whether a sheet is present on an adhesive surface of the information processing device; and
if the information processing device is not attached, transmitting an identifier of the information processing device and information indicating that the information processing device is not attached.

9. A non-transitory computer readable medium storing a program causing a computer to execute a process for information processing, the process comprising:
detecting whether an information processing device including the computer is attached to an object by detecting whether a sheet is present on an adhesive surface of the information processing device; and
if the information processing device is not attached, transmitting an identifier of the information processing device and information indicating that the information processing device is not attached.

10. A non-transitory computer readable medium storing a program causing a computer to execute a process for information processing, the process comprising:
if information indicating that an attachable information processing device is attached is received from the attachable information processing device, extracting expiry information corresponding to an identifier of the attachable information processing device; and
outputting a warning if an expiry date indicated by the expiry information has passed,
wherein the attachable information processing device includes at least one hardware processor configured to implement:
a detection unit that detects whether the attachable information processing device is attached to an object by detecting whether a sheet is present on an adhesive surface of the information processing device, and
a transmission unit that transmits, if the attachable information processing device is not attached, the identifier of the attachable information processing device and information indicating that the attachable information processing device is not attached, and if the attachable information processing device is attached, the identifier of the attachable information processing device and information indicating that the attachable information processing device is attached.

11. A non-transitory computer readable medium storing a program causing a computer to execute a process for image processing, the process comprising:
obtaining, from an attachable information processing device, information for uniquely identifying the attachable information processing device; and
printing content of the information on a surface of the attachable information processing device,
wherein the attachable information processing device includes at least one hardware processor configured to implement
a detection unit that detects whether the attachable information processing device is attached to an object by detecting whether a sheet is present on an adhesive surface of the information processing device, and
a transmission unit that transmits, if the attachable information processing device is not attached, an identifier of the attachable information processing device and information indicating that the attachable information processing device is not attached.

12. The information processing device according to claim 1, wherein the detection unit detects that the information processing device is not attached to the object in response to a detection that the sheet is present on the adhesive surface.

13. The information processing device according to claim 1, wherein the detection unit detects whether the sheet is present on the adhesive surface by detecting whether a circuit of the information processing device is in an electrically conductive state, and
the presence of the sheet on the adhesive surface prevents the circuit from entering the electrically conduct state.

14. The information processing device according to claim 1, further comprising:
an radio frequency identification (RFID) tag comprising the at least one hardware processor and the adhesive surface.

15. The information processing device according to claim 14, wherein
the surface comprises a quick response (QR) code, a management identification (ID), a creation date and time, and an expiry,
the management ID is printed on the surface of the RFID tag other than at the QR code and indicates a device to which the RFID tag is predetermined to be attached,
the QR code is printed on the surface and comprises the management ID in a form of the QR code,
the creation date and time is printed on the surface and indicates a date and a time at which the RFID tag was created, and
the expiry is printed on the surface and indicates a predetermined expiry date of the RFID tag, and
the RFID tag is configured to transmit the management ID, the creation date and time, and the expiry.

16. The information processing device according to claim 1, wherein the detection unit further detects whether the adhesive surface is detached from the object after being attached to the object, and
the transmission unit further transmits an indication that the adhesive surface is detached from the object after being attached to the object in a case in which the adhesive surface is detached from the object after being attached to the object.
